(19) United States
(12) Patent Application Publication
(10) Pub. No.: US 2007/0040045 A1
(43) Pub. Date: Feb. 22, 2007

(54) Rotary sprinkler with reduced wear

(76) Inventor: Boaz Cohen, Hadera (IL)

Correspondence Address: NATH & ASSOCIATES, 112 South West Street, Alexandria, VA, 22314, US

(21) Appl. No.: 10/564,357

(22) PCT Filed: Jul. 1, 2004
(86) PCT No.: PCT/IL04/00584

§ 371 Date: Aug. 16, 2006

(30) Foreign Application Priority Data
Jul. 15, 2003 (IL) 156931

(51) Int. Cl. B05B 3/04

(52) U.S. Cl. 239/222.17; 239/222.11

(57) ABSTRACT

A rotary sprinkler comprising a rotor (16) with an axle (38) having a tip, and a thrust hearing (14) with a socket (26) having a bottom (30), the socket being adapted to receive for rotation the axle so that the tip abuts the bottom in a contact zone. The sprinkler further comprises a hard element (42) constituting a part of the bottom or of the tip. The hard element (42) is made of harder material than the axle or the socket, thereby reducing their wear.

### FIELD OF THE INVENTION

This invention relates to rotary sprinklers, in particular to dynamic sprinklers with unlimited speed of rotation where an operating rotor is supported in a thrust bearing.

### BACKGROUND OF THE INVENTION

Dynamic rotary sprinklers are characterized by high rotational speed, which is due to the lack of braking mechanism. Their advantages lie in the simple construction that accounts for their low price. Their shortcomings are relatively small range (radius) of irrigation and small water droplets emitted as a result of the high speed of rotation.

A typical dynamic rotary sprinkler known in the art is shown in FIG. 1. The sprinkler 10 is made of plastic parts: a sprinkler base 12 mountable to irrigation water pipe (not shown), a thrust bearing 14, a rotor (swivel) 16, and a connecting bridge 18. The base 12 has an axial inlet nozzle 20, a coaxial intermediate bore 22 and a coaxial exit chamber 24. The thrust bearing 14 has an axial socket 26 comprising a bore 28 and a bottom 30. The rotor 16 has a base 32 with outlet channel 34, a cap 36, and an axle 38 with a tip 39.

The sprinkle base 12 and the bearing 14 are snapped into the connecting bridge 18 in coaxial relation, with the rotor 16 located between them. The rotor axle 38 is received in the socket 26 while the rotor base 32 is received in the intermediate bore 22 so that the rotor may move axially and rotate freely.

In operation, when water jet exits from the inlet nozzle 20, the jet lifts the rotor 16 until the tip 39 of the axle abuts the bottom 30 of the socket, while the base 32 is still in the bore 22. The water jet passes through the curved channel 34 and leaves the rotor spreading in droplets about the surrounding area. The outlet channel 34 has some curvature also in the plane perpendicular to the rotor's axis of rotation, whereby the water jet creates a reactive force that imparts high rotation speed to the rotor.

In still state, the rotor 16 falls down into the sprinkler base 12, whereby the cap 36 closes the exit chamber 24 preventing contamination of the inlet nozzle by external factors (see also FIG. 6). Understandably, in this lower position of the rotor, the axle 38 still remains in the socket 26. The axial distance between the upper and the lower position of the rotor provides for free exit of the water jet from the channel 34.

### SUMMARY OF TEE INVENTION

According to the present invention, there is provided a rotary sprinkler comprising a rotor with an axle having a tip, and a trust bearing with a socket having a bottom, the socket being adapted to receive for rotation the axle so that the tip abuts the bottom in a contact zone, wherein the sprinkler further comprises a hard element constituting a part of the bottom or of the tip. The hard element is made of harder material than the axle or the socket, thereby reducing their wear.

The hard element is preferably made of industrial sapphire stone, industrial ruby stone, ceramics, steel, or glass.

The hard element is preferably formed as a flat plate, a concave plate, a pin, or a ball, and its surface in the contact zone is polished.

In one embodiment of the sprinkler, the hard element is a stainless steel ball locked in the bottom of the socket or in the tip.

In another embodiment, the rotary sprinkler comprises two hard elements, one at the socket bottom, one at the axle tip.

The above-described construction of the sprinkler provides for reduced friction and improved friction endurance of the rotor axle and the thrust bearing.

According to another aspect of the present invention, the thrust bearing has a socket with an inlet opening of diameter D0 and a peripheral wall between the opening and the bottom. The socket receives slidably and rotatably the axle through the inlet opening so that the tip can abut the bottom. The tip has diameter D1 close to D0, while an adjacent portion of the axle has diameter D2<D1, such that, when the tip abuts the bottom, an open annular gap is formed between the axle and the peripheral wall, and when the tip is aligned with the inlet opening, the inlet opening is essentially closed.

The tip may be formed as a ball, as a cylinder, as a cone, as a disc, or as another body of rotation.

Enlarging the diameter of the rotor axle tip prevents the penetration of contaminating particles into the contact zone of the tip and the socket both in the upper (operative) position of the rotor with the tip abutting the bottom and in the lower position with the tip aligned with the inlet opening of the socket. Since the enlarged tip is relatively short, a contaminating particle is less likely to be trapped between the axle and the socket wall.

Preferably, the rotary sprinkler of the present invention has both a short enlarged tip, and a hard element, to obtain double effect.

### BRIEF DESCRIPTION OF THE DRAWINGS

In order to understand the invention and to see how it may be carried out in practice preferred embodiments will now be described, by way of non-limiting example only, with reference to the accompanying drawings, in which:

FIG. 1 illustrates a rotary (dynamic) sprinkler known in prior art.

FIGS. 2A and 2B show rotor-bearing assembly with a hard disc insert according to the present invention.

FIG. 3 is an enlarged view of the axle tip and the socket bottom with a stainless steel ball insert according to a further embodiment of the present invention.

FIG. 4 shows the rotor-bearing assembly of FIG. 3 according to another embodiment of the present invention.

FIG. 5 shows a rotor-bearing assembly according to the present invention, with two hard elements;

FIG. 6 shows a rotary sprinkler with an enlarged diameter tip of the rotor axle according to the present invention; and

FIG. 7 shows a rotor-bearing assembly with an enlarged diameter tip of the rotor axle and a hard disc insert according to the present invention.

### DETAILED DESCRIPTION OF THE INVENTION

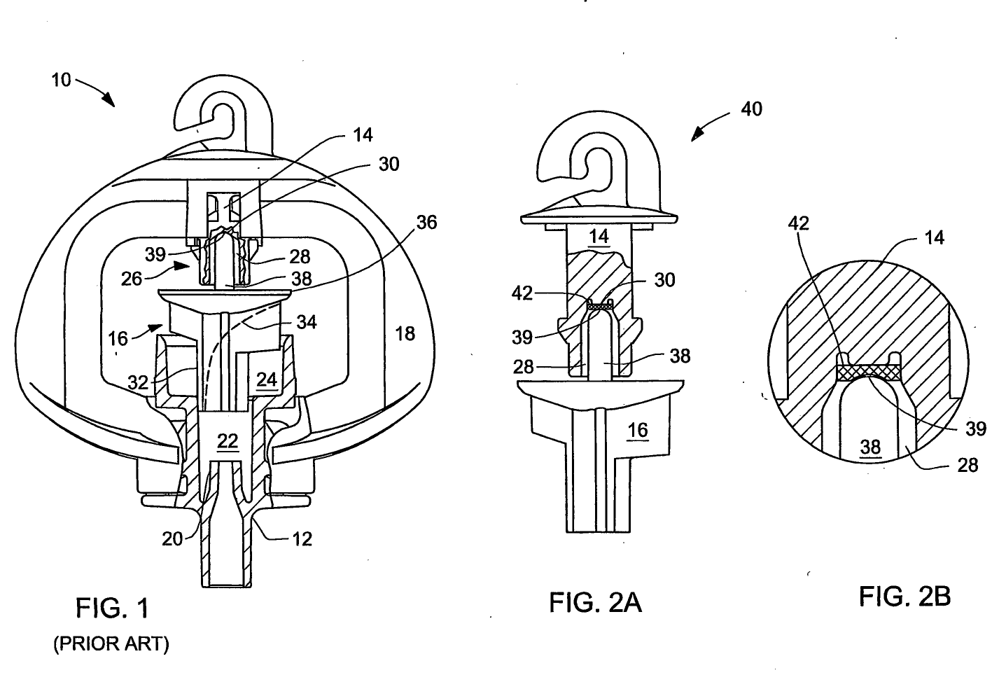

A typical dynamic rotary sprinkler known in the prior art was described above with reference to FIG. 1. A rotor-bearing assembly 40 of a similar rotary sprinkler in accordance with one embodiment of the present invention, is shown in FIG. 2A, without the sprinkler base and the connecting bridge, which are generally the same as in FIG. 1.

As shown in FIG. 2, the rotor-bearing assembly comprises the thrust bearing 14 and the rotor 16, both made of plastic material. The rotor 16 has an axle 38 with a tip 39, while the thrust bearing 14 has an axial socket 26 comprising a bore 28 and a bottom 30.

Furthermore, the bearing 14 is equipped with a wear-resistant insert 42 made of material which is much harder than the plastic material of the rotor and the bearing. The insert is a flat polished disc which is corrosion-proof in the field, i.e. in water solution of fertilizers and other chemicals. The disc may be made of industrial sapphire stone, industrial ruby stone, stainless steel, glass, ceramics or others.

The tip 39 abuts the hard insert 42 in a contact zone, forming a friction pair with lower friction coefficient than the pair of two plastic details tip-socket, whereby the wear of the tip and the socket in the contact zone is much lower. As shown in FIG. 2B, the disc 42 may be concave in the center in order to stabilize the position of the axle 38.

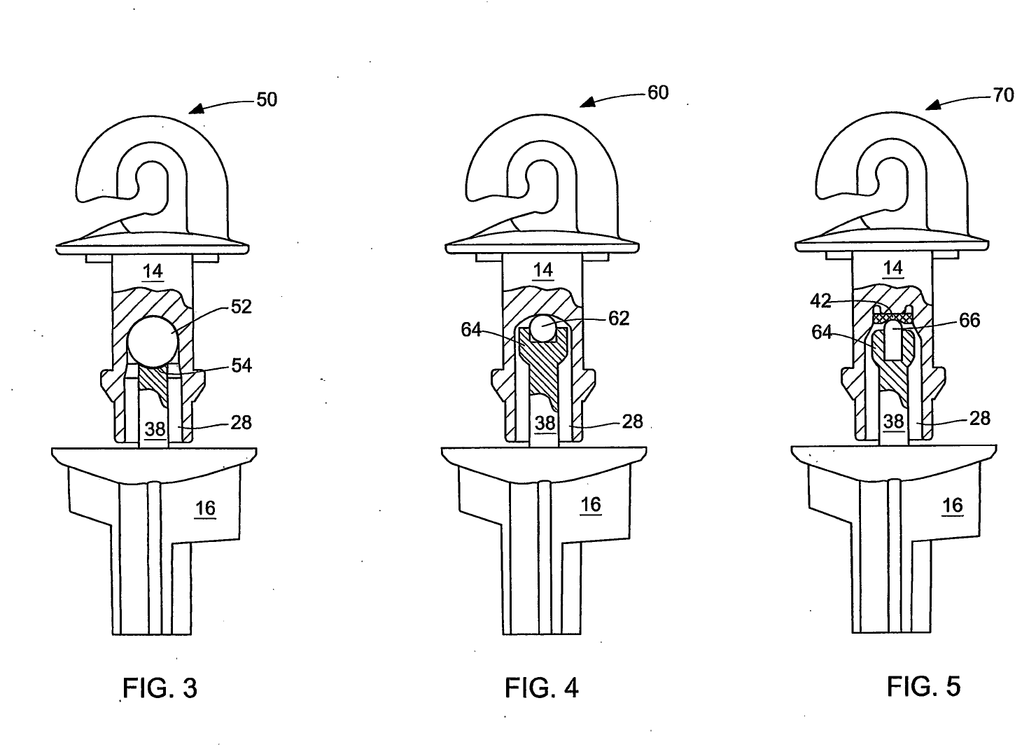

With reference to FIG. 3, another rotor-bearing assembly 50 is shown where the hard insert is in the form of a stainless steel ball 52 locked at the bottom of the socket 28. The tip 54 of the rotor axle 38 in this case is concave in order to stabilize the position of the axle 38. The hard insert may be as well fixed to the axle tip, as shown in FIG. 4 for a rotor-bearing assembly 60, where a stainless steel ball 62 is locked in the tip 64 of the axle 38.

As shown in FIG. 5, the friction pair of the present invention in a rotor-bearing assembly 70, may be constituted by two hard elements: a pin 66 embedded in the tip 64 of the rotor axle 38, and a hard insert 42 locked in the socket 28. Such friction pair would provide even lower friction and wear.

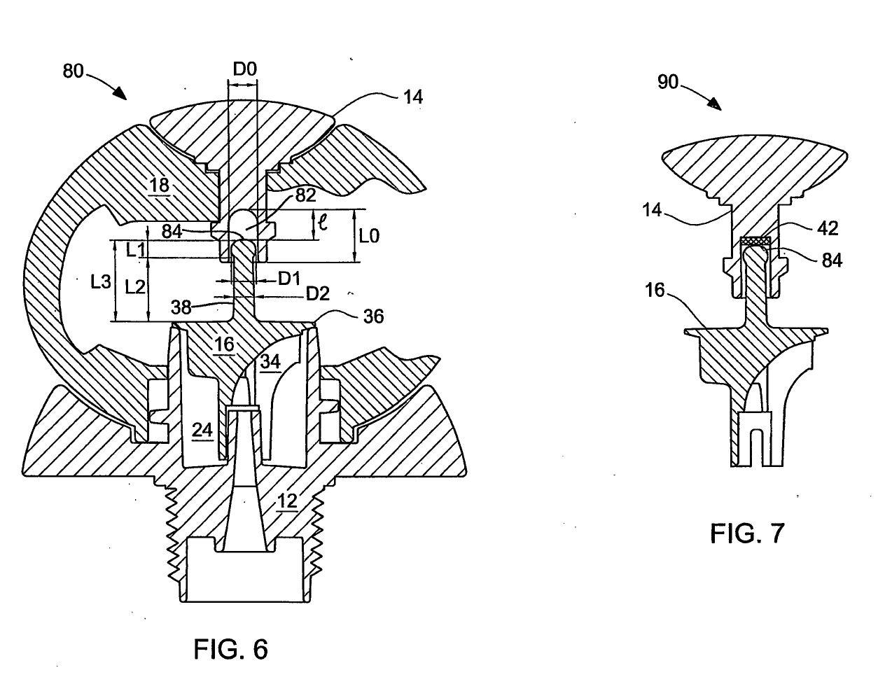

FIG. 6 illustrates a rotary sprinkler 80 with an enlarged axle tip according to another aspect of the present invention. The rotary sprinkler 80 has a thrust bearing 14 with a socket 82 formed as a cylinder bore of diameter D0 and depth L0. The axle 38 has length L3 greater than L0 so that the axle can be axially displaced inside the socket 82 within a distance l<L0 from the bottom. The tip 84 of the axle has diameter D1 close to D0 and short axial length L1<<L0, while the remainder major part of the axle 38, with length L2, has narrower diameter D2.

Enlarging the diameter of the rotor axle tip 84 prevents penetration of contaminating particles into the contact zone between the tip 84 and the socket 82, both in the lower position of the rotor shown in FIG. 6, where the tip is aligned with the bore opening, and in the upper (operative) position, where the tip abuts the bottom (seen in FIG. 7). As the enlarged tip 84 length L1 is much shorter than the bore length L0, an open annular gap is formed below the tip, between the socket peripheral wall and the narrower part L2 of the axle 38, when the rotor is in the upper position. Thus, even if a contaminating particle is entrapped in the contact zone as the rotor jumps to the operative position, the particle is very likely to fall out via the gap without causing much wear. The gap also prevents jamming of the axle in the socket, which would be very likely, if a substantial part of the axle had diameter close to the bore diameter D0.

As shown in FIG. 7, a rotary sprinkler 90 of the present invention may have both a short enlarged tip 84 in a cylinder bore, and a friction-reducing insert 42, to obtain double effect.

Although a description of specific embodiments has been presented, it is contemplated that various changes could be made without deviating from the scope of the present invention. For example, the enlarged tip of the present invention may be formed as a ball, cylinder, cone, etc., or the socket may be not exactly cylindrical.

1-21. (canceled)

22. A rotary sprinkler comprising a rotor with an axle having a tip, and a thrust bearing with a socket having a bottom, said socket being adapted to receive for rotation said axle so that said tip abuts said bottom in a contact zone, wherein said sprinkler further comprises a hard element constituting at least a part of said bottom including said contact zone, said element being made of harder material than said tip.

23. The rotary sprinkler of claim 22, wherein said tip is made of plastic.

24. The rotary sprinkler of claim 23, wherein said rotor with the axle and the tip is one integrally molded plastic part.

25. The rotary sprinkler of claim 22, wherein said hard element has polished surface in the contact zone.

26. The rotary sprinkler of claim 22, wherein said hard element has concave surface in the contact zone.

27. The rotary sprinkler of claim 22, wherein said hard element is made of industrial sapphire stone.

28. The rotary sprinkler of claim 22, wherein said hard element is made of industrial ruby stone.

29. The rotary sprinkler of claim 22, wherein said hard element is made of ceramics.

30. The rotary sprinkler of claim 22, wherein said hard element is made of glass.

31. The rotary sprinkler of claim 22, wherein said hard element is made of stainless steel.

32. The rotary sprinkler of claim 22, wherein said hard element is formed as a plate or as a ball.

33. The rotary sprinkler of claim 32, wherein said hard element is a stainless steel ball locked in the bottom of said socket.

34. The rotary sprinkler of claim 33, wherein said tip is concave.

35. The rotary sprinkler of claim 22, wherein said socket has an inlet opening of diameter D0 and a peripheral wall between said inlet opening and said bottom, said socket being adapted to receive slidably said axle through said inlet opening, wherein said tip has diameter D1 close to D0 while an adjacent portion of said axle has diameter D2<D1, such that, when said tip abuts said bottom, an open annular gap is formed between said axle and said peripheral wall, and when said tip is aligned with said inlet opening, said inlet opening is essentially closed.

36. The rotary sprinkler of claim 35, wherein said rotor is adapted to slide, under water flow action, into a position where said tip abuts said bottom, and is adapted to slide back, in absence of water flow, into a position where said tip is aligned with said inlet opening.

37. The rotary sprinkler of claim 36, wherein said sprinkler is adapted to operate with said socket disposed above said rotor.

38. The rotary sprinkler of claim 35, wherein said tip is formed as one of the following: a ball, a cylinder, a cone, a disc, or another body of rotation.

39. A hard element for use in a rotary sprinkler comprising a rotor with an axle having a tip, and a thrust bearing with a socket having a bottom, said socket receiving said axle for rotation so that said tip abuts said bottom, said hard element being formed for fixing in said bottom, being made of harder material than said tip, and having a contact surface to meet said tip.

40. The hard element of claim 39, wherein said contact surface is polished.

41. The hard element of claim 39, wherein said contact surface is concave.

42. The hard element of claim 39, formed as a plate.

43. The hard element of claim 39, made of industrial sapphire stone.

44. The hard element of claim 39, made of industrial ruby stone.

45. The hard element of claim 39, made of ceramics.

46. The hard element of claim 39, made of glass.

47. The hard element of claim 39, made of stainless steel.
